(19) United States
(12) Patent Application Publication
(10) Pub. No.: US 2014/0026871 A1
(43) Pub. Date: Jan. 30, 2014

(54) Supercharger Control Device

(71) Applicant: Gary Haven, Palmdale, CA (US)

(72) Inventor: Gary Haven, Palmdale, CA (US)

(21) Appl. No.: 13/872,238

(22) Filed: Apr. 29, 2013

Related U.S. Application Data
(60) Provisional application No. 61/676,516, filed on Jul. 27, 2012.

(51) Int. Cl. F02B 33/00

(52) U.S. Cl. CPC F02B 33/00
USPC 123/564

(57) ABSTRACT

A supercharger control device that enables the driver of a supercharged vehicle to secure the supercharger with a keyed or other type of switch is disclosed. The supercharger control device can leave the supercharged vehicle with a significant reduction in power, making the supercharged vehicle safer overall. The supercharger control device comprises a check valve and a solenoid valve in parallel configuration with the check valve. The check valve is positioned in-line between a vacuum source and an actuator of a supercharger. The check valve maintains vacuum to the actuator of the supercharger, keeping the supercharger off-line. The solenoid valve is normally in a closed position and is in parallel communication with the check valve. Thus, when the solenoid valve is in an open position, the check valve is bypassed, restoring power to the supercharger. Further, the solenoid valve is typically activated by a switch.

### CROSS-REFERENCE

This application claims priority from Provisional Patent Application Ser. No. 61/676,516 filed Jul. 27, 2012.

### BACKGROUND

Normally a supercharger in a supercharged vehicle has a bypass that is held open by a vacuum-operated actuator that prevents the intake air from going through the power side of the supercharger and thus enabling the supercharger. When manifold vacuum drops under acceleration, the bypass actuator that was open starts to close and the intake air is now directed through the supercharger where additional horsepower for the vehicle is produced. This can result in sensitive throttle responses, such that even light pressure on the throttle will result in significant increases in speed, and in bad weather conditions, can make driving a supercharged vehicle extremely dangerous. Further, inexperienced drivers may not be able to handle the additional power that comes from driving a supercharged vehicle. Thus, a way to remove and restore major horsepower from and to the engine with the flip of a switch is necessary.

The present invention enables the driver of a supercharged vehicle to engage/disengage the supercharger with the flip of a switch. When desired, the supercharger control device can temporarily disable the supercharger thus resulting in a significant reduction in horsepower and a much safer vehicle. Individuals with young family members or inexperienced drivers would benefit from the increased safety and control that this device provides. Specifically, the supercharger control device comprises a check valve that maintains a vacuum to the actuator at all times to keep the supercharger off-line under any condition. This device also comprises a solenoid valve to keep the supercharger off-line until a switch is activated in the vehicle cabin, restoring the supercharger system to the original configuration. Thus, anyone looking for greater control over their supercharged vehicle would benefit from this device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a supercharger control device that enables the driver of a supercharged vehicle to enable or disable the supercharger with the flip of a switch from the vehicle cabin. The supercharger control device can leave the supercharged vehicle with a significant reduction in power, making the supercharged vehicle safer overall. The supercharger control device comprises a check valve and a solenoid valve in parallel configuration with the check valve. The check valve is positioned in-line between a vacuum source and an actuator of a supercharger. The check valve maintains vacuum to the actuator of the supercharger, keeping the supercharger off-line. The solenoid valve is normally in a closed position and is in parallel communication with the check valve. Thus, when the solenoid valve is in an open position, the check valve is bypassed, restoring power to the supercharger. Further, the solenoid valve may be activated by a switch or keyed switch in the vehicle cabin.

In a preferred embodiment, the solenoid valve is in parallel communication or configuration with the check valve via at least one barbed pipe elbow, at least one barbed pipe tee, and at least one vacuum hose. Thus, when the solenoid valve is in a closed position, pressurized air flows through the intake hose, and passes through the check valve and out through an exit hose. Once the switch is activated, the solenoid valve is moved to an open position, and the pressurized air now bypasses the check valve and flows through the solenoid valve which places the system back in the original configuration and restores the supercharger to full power. Typically, the solenoid valve, the check valve, and the barbed pipe elbows, barbed pipe tees, and vacuum hose are encased in a housing and mounted in a supercharged vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the supercharger control device in accordance with the disclosed architecture.

FIG. 2 illustrates a perspective view of the supercharger control device encased in a housing with the lid removed in accordance with the disclosed architecture.

FIG. 3 illustrates a perspective view of the supercharger control device encased in a housing with the lid secured in accordance with the disclosed architecture.

FIG. 4 illustrates a perspective view of a prior art actuator of a supercharger in accordance with the disclosed architecture.

FIG. 5 illustrates a perspective view of the supercharger control device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a supercharger control device that enables the driver of a supercharged vehicle to enable/disable the supercharger with the turn of a keyed or manual switch in the vehicle cabin. The supercharger control device can leave the supercharged vehicle with a significant reduction in power, making the supercharged vehicle safer overall. Individuals with young family members or inexperienced drivers would benefit from the increased safety and control this device provides. Additionally, anyone looking for greater control over their supercharged vehicle would benefit from this device as well.

The supercharger control device comprises a check valve and a solenoid valve in parallel configuration with the check valve. The check valve is positioned in-line between a vacuum source and an actuator of a supercharger. The check valve maintains vacuum to the actuator of the supercharger, keeping the supercharger off-line. The solenoid valve is normally in a closed position and is in parallel communication with the check valve. Thus, when the solenoid valve is in an open position, the check valve is bypassed, restoring power to the supercharger. Further, the solenoid valve is typically activated by a switch.

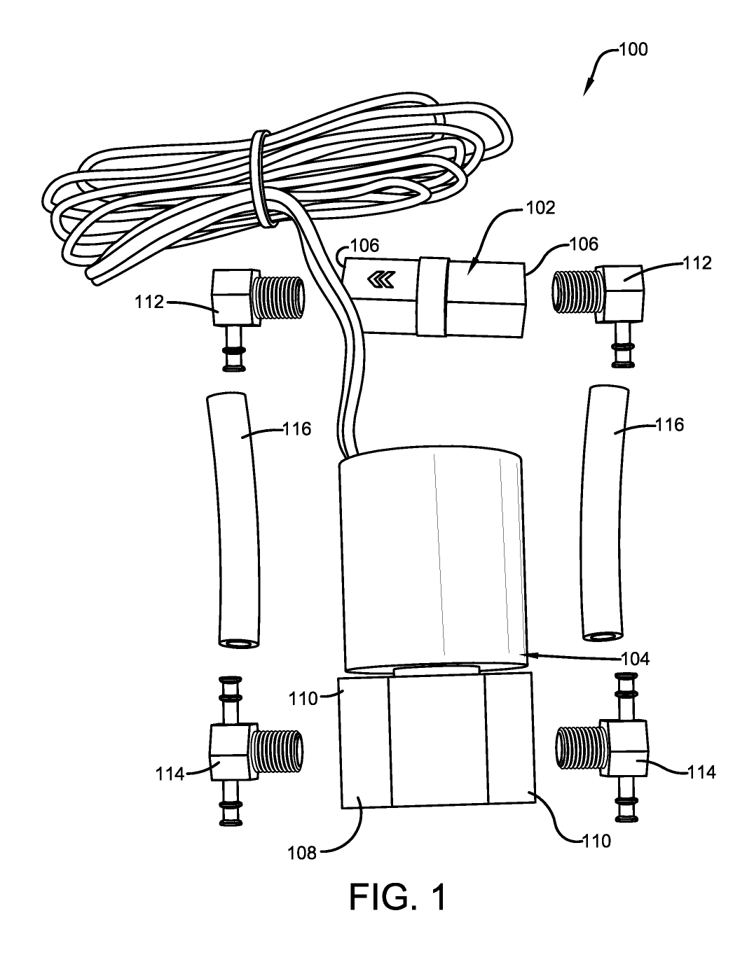

Referring initially to the drawings, FIGS. 1-3 illustrate the supercharger control device 100 that enables the driver of a supercharged vehicle to enable/disable the supercharger with the flip of a switch. The supercharger control device 100 can leave the supercharged vehicle with a significant reduction in power, making the supercharged vehicle safer overall. The supercharger control device 100 comprises a check valve 102 and a solenoid valve 104 in parallel configuration with the check valve 102.

Typically, the check valve 102 is cylindrical in shape, however any other suitable shape can be used as is known in the art without affecting the overall concept of the invention. The check valve 102 would generally be constructed as a typical prior art check valve. Further, the check valve 102 would generally be constructed of aluminum, stainless steel, or plastic, etc., though any other suitable material may be used to manufacture the check valve 102 as is known in the art without affecting the overall concept of the invention. The check valve 102 is approximately between 1¼ and 1⅜ inches long as measured from opposing ends 106, and approximately between ¾ and 9/16 inches in diameter.

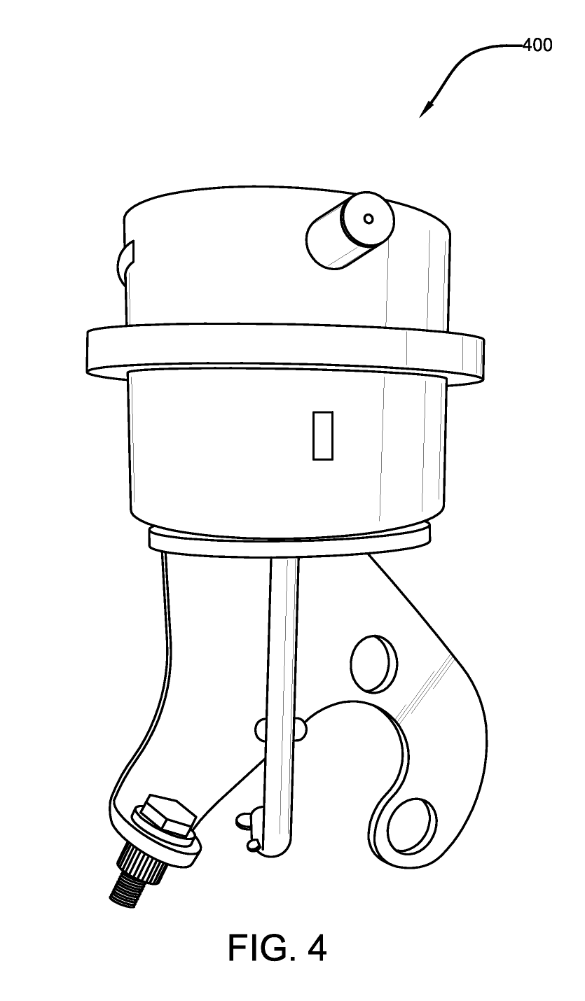

The check valve 102 is positioned in-line (in fluid communication) between a vacuum source and an actuator (See FIG. 4) of a supercharger. The check valve 102 maintains vacuum to the actuator of the supercharger, keeping the supercharger off-line or disabled. Specifically, the supercharger has a vacuum-operated bypass actuator, such that when vacuum is maintained, the supercharger remains off-line. The vacuum source can be any typical prior art vacuum source used with supercharged vehicles, such as an intake manifold vacuum.

Typically, the solenoid valve 104 is cylindrical in shape, however any other suitable shape can be used as is known in the art without affecting the overall concept of the invention. The solenoid valve 104 would generally be constructed as a typical prior art solenoid valve, and thus comprises copper windings, at least one plunger, a gate, and a valve body 108. The valve body 108 would generally be constructed of aluminum, stainless steel, or plastic, etc., though any other suitable material may be used to manufacture the valve body 108 as is known in the art without affecting the overall concept of the invention. The solenoid valve 104 is approximately between 1¾ and 1⅜ inches long as measured from opposing ends 110, and approximately between 1¼ and 1½ inches in diameter.

The solenoid valve 104 is normally in a closed position when the supercharger is disabled, and is in parallel communication or configuration with the check valve 102. Thus, when the solenoid valve 104 is in an open position, the check valve 102 is bypassed, such that the air from the intake hose 119 bypasses the check valve, restoring power to and enabling the supercharger. Further, the solenoid valve 104 is typically a 12 volt solenoid valve, however any other suitable solenoid valve can be used as is known in the art without affecting the overall concept of the invention. The solenoid valve 104 is typically activated by a keyed or manual switch (not shown). The switch is in electrical communication with the solenoid valve 104 to engage the solenoid valve 104 in the open position. Typically, the switch is a 12 volt lighted rocker switch, positioned in a cabin of a supercharged vehicle, however the switch can be any suitable switch or activator as is known in the art without affecting the overall concept of the invention, and does not have to be positioned in the vehicle cabin, although it is desirable to do so.

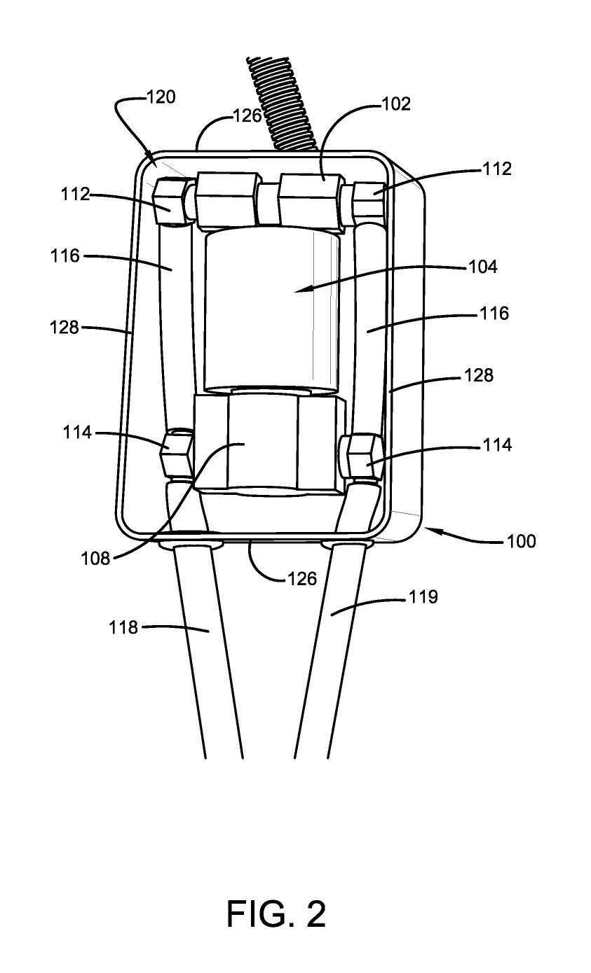

The solenoid valve 104 is in parallel communication or configuration with the check valve 102 and is positioned in the system before and after the check valve 102 (as shown in FIGS. 1-2). Typically, the check valve 102 and the solenoid valve 104 are in parallel communication or configuration via at least one barbed pipe elbow 112, at least one barbed pipe tee 114, and at least one vacuum hose 116. Specifically, the check valve 102 is connected at both ends via a barbed pipe elbow 112, or other suitable connector as is known in the art. The barbed pipe elbows are each connected to a barbed pipe tee 114, or other suitable connector as is known in the art, via a vacuum hose 116. The barbed pipe tees 114 then connect to both sides of the solenoid valve 104, which configures the solenoid valve 104 and the check valve 102 in parallel configuration. Thus, when the solenoid valve 104 is in a closed position, pressurized air flows through the intake hose 119, and passes through the check valve 102 and out through an exit hose 118. Once the switch is activated, the solenoid valve 104 is moved to an open position, and the pressurized air now bypasses the check valve 102 and flows through the solenoid valve 104 which places the system back in the original configuration and restores the supercharger to full power.

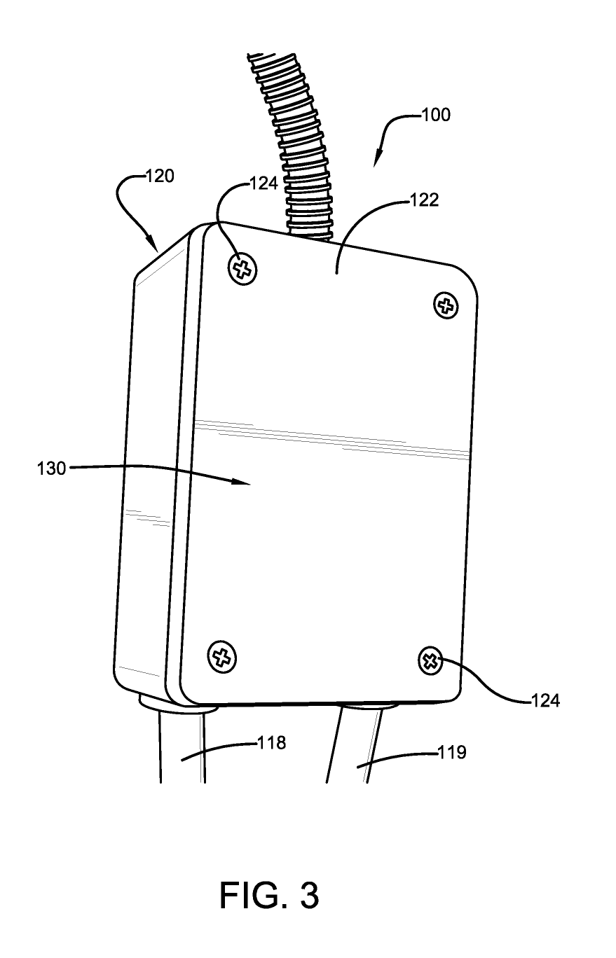

Typically, the solenoid valve 104, the check valve 102, and the barbed pipe elbows 112, barbed pipe tees 114, and vacuum hose 116 are encased in a housing 120 (as shown in FIGS. 2-3). The housing 120 typically comprises a lid 122 (as shown in FIG. 3) which can be secured to the housing 120 via screws 124, or any other suitable fasteners as is known in the art. The housing 120 retains and protects the components of the supercharger control device 100 and allows the device 100 to be mounted within a supercharged vehicle. However, the housing 120 is not needed and the supercharger control device 100 can function without the housing 120.

If a housing 120 is used, then typically the housing 120 is rectangular in shape, however any other suitable shape can be used as is known in the art without affecting the overall concept of the invention, as long as the housing can substantially encapsulate the components of the supercharger control device 100. The housing 120 would generally be constructed of aluminum, stainless steel, or plastic, etc., though any other suitable material may be used to manufacture the housing 120 as is known in the art without affecting the overall concept of the invention. The housing 120 is approximately between 3¾ and 3⅝ inches long as measured from opposing top and bottom ends 126, and approximately between 2% and 2½ inches wide as measured from opposing sides 128, and approximately between 1% and 1½ inches deep as measured from the front surface 130 to the back surface (not shown).

FIG. 4 illustrates a prior art actuator 400 of a supercharger (not shown). As stated supra, the check valve 102 is positioned in-line between a vacuum source and an actuator 400 of a supercharger. The check valve 102 maintains vacuum to the actuator 400 of the supercharger, keeping the supercharger off-line. Specifically, the supercharger has a vacuum-operated bypass actuator 400, but any suitable actuator 400 can be used as is known in the art, such that when vacuum is maintained, the supercharger remains off-line or disabled. The vacuum source can be any typical prior art vacuum source used with supercharged vehicles, such as an intake manifold vacuum.

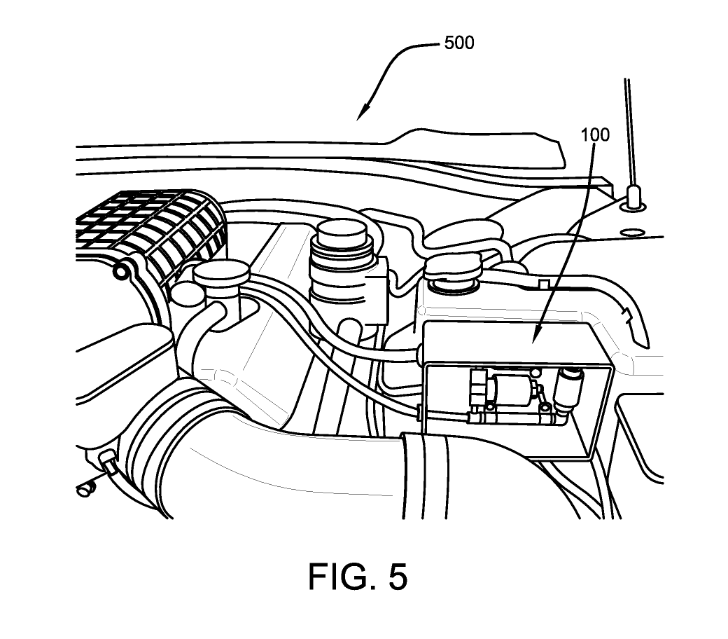

FIG. 5 illustrates the supercharger control device 100 in use. In operation, a user (not shown) would choose a supercharger control device 100. The user would then connect the check valve 102 and the solenoid valve 104 in parallel configuration?. Specifically, the user would connect the check valve at both ends to a barbed pipe elbow. The user then connects the barbed pipe elbows to a barbed pipe tee via a vacuum hose. The user would then connect the barbed pipe tees to both sides of the solenoid valve 104. Thus, when the solenoid valve 104 is in a closed position, pressurized air flows through the intake hose, and passes through the check valve 102 and out through an exit hose. Once the solenoid valve 104 is moved to an open position, the pressurized air now bypasses the check valve 102 and flows through the solenoid valve 104.

Once the check valve 102 and the solenoid valve 104 are in parallel configuration, the user can then encase the check valve 102 and the solenoid valve 104 in a housing 120. The user can then secure the lid of the housing 120 and can mount the supercharger control device 100 in a supercharged vehicle 500. The user can then mount a rocker switch (not shown) in the cabin of the supercharged vehicle 500 which is in electrical communication with the supercharger control device 100. The user would then operate the supercharger control device 100 via flipping the rocker switch to a first position, and thus activating the solenoid valve 104. Thus, once the switch is activated, the solenoid valve 104 is moved to an open position, and the pressurized air now bypasses the check valve 102 and flows through the solenoid valve 104 which places the system back in the original configuration and restores the supercharger to full power.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A supercharger control device, comprising:
a check valve positioned in-line between a vacuum source and an actuator of a supercharger;
wherein the check valve maintains vacuum to the actuator of the supercharger, keeping the supercharger off-line; and
a solenoid valve normally in a closed position and in parallel configuration with the check valve; and
wherein when the solenoid valve is in an open position, the check valve is bypassed, restoring power to the supercharger.

2. The supercharger control device of claim 1, further comprising a switch in communication with the solenoid valve to engage the solenoid valve in the open position.

3. The supercharger control device of claim 2, wherein the switch is a 12 volt lighted rocker switch, positioned in a cabin of a supercharged vehicle.

4. The supercharger control device of claim 3, wherein the solenoid valve is a 12 volt solenoid valve.

5. The supercharger control device of claim 1, further comprising a housing for encasing the check valve and the solenoid valve.

6. The supercharger control device of claim 1, wherein the check valve and the solenoid valve are in parallel configuration via at least one barbed pipe elbow.

7. The supercharger control device of claim 6, wherein the check valve and the solenoid valve are in parallel configuration via at least one barbed pipe tee.

8. The supercharger control device of claim 7, wherein the check valve and the solenoid valve are in parallel configuration via at least one vacuum hose.

9. The supercharger control device of claim 1, wherein the actuator of the supercharger is a vacuum-operated actuator.

10. A supercharger control device, comprising:
a check valve positioned in-line between a vacuum source and an actuator of a supercharger;
wherein the check valve maintains vacuum to the actuator of the supercharger, keeping the supercharger off-line;
a solenoid valve normally in a closed position and in parallel configuration with the check valve;
wherein when the solenoid valve is in an open position, the check valve is bypassed, restoring power to the supercharger; and
a switch in communication with the solenoid valve to engage the solenoid valve in the open position.

11. The supercharger control device of claim 10, further comprising a housing for encasing the check valve and the solenoid valve.

12. The supercharger control device of claim 10, wherein the check valve and the solenoid valve are in parallel configuration via at least one barbed pipe elbow, at least one barbed pipe tee, and at least one vacuum hose.

13. The supercharger control device of claim 10, wherein the switch is a 12 volt lighted rocker switch, positioned in a cabin of a supercharged vehicle.

14. The supercharger control device of claim 13, wherein the solenoid valve is a 12 volt solenoid valve.

15. The supercharger control device of claim 10, wherein the actuator of the supercharger is a vacuum-operated actuator.

16. A supercharger control system, comprising:
a supercharger comprising an actuator and a vacuum source, and positioned in a supercharged vehicle; and
a supercharger control device comprising:
a check valve positioned in-line between the vacuum source and the actuator of the supercharger;
wherein the check valve maintains vacuum to the actuator of the supercharger, keeping the supercharger off-line;
a solenoid valve normally in a closed position and in parallel configuration with the check valve; and
wherein when the solenoid valve is in an open position, the check valve is bypassed, restoring power to the supercharger.

17. The supercharger control system of claim 16, further comprising a switch in communication with the solenoid valve to engage the solenoid valve in the open position.

18. The supercharger control system of claim 16, wherein the actuator of the supercharger is a vacuum-operated actuator.

19. The supercharger control system of claim 16, further comprising a housing for encasing the check valve and the solenoid valve.

20. The supercharger control system of claim 16, wherein the check valve and the solenoid valve are in parallel configuration via at least one barbed pipe elbow, at least one barbed pipe tee, and at least one vacuum hose.
